(19) United States
(12) Patent Application Publication
(10) Pub. No.: US 2003/0168497 A1
(43) Pub. Date: Sep. 11, 2003

(54) Method and device for bleed out control in solder bonding

(76) Inventors: Stephanie Elisabeth Anna Radeck, Singapore (SG); Franz Michael Anastasius Cotsis, Singapore (SG)

Correspondence Address: Lawrence S Roach, Jaeckle Fleischmann & Mugel, 39 State Street, Suite 200, Rochester, NY, 14614-1310, US

(21) Appl. No.: 10/276,492

(22) PCT Filed: May 23, 2001
(86) PCT No.: PCT/SG01/00099

(30) Foreign Application Priority Data
May 26, 2000 (SG) 200002886-0

(51) Int. Cl. B23K 31/02; B23K 37/04

(52) U.S. Cl. 228/256; 228/33; 228/49.5

(57) ABSTRACT

An improved die placement and bonding apparatus with bleed out control for attachment of a die onto the prescribed surface of a leadframe. The apparatus contains a bond frame provided with an alignment mechanism, and a die placement mechanism. The frame has a perimeter side wall with a base defining a predetermined area therein, with dimensions larger than the dimensions of the die. The side wall is used to provide a solder liquid tight seal when it is placed on a prescribed surface of the leadframe. The alignment mechanism is coupled to the frame and allows the frame to be properly aligned with the leadframe before it is lowered onto the prescribed surface. The die placement mechanism is used for delivering and placing the die onto the liquid solder on the leadframe within the side wall.

### FIELD OF THE INVENTION

The present invention relates to die bonding technology in the electronic industry. In particular, the present invention relates to a method and apparatus for die attachment by liquid solder.

### BACKGROUND

Solder die bonding involves the dispensing of solder onto a heated leadframe followed by placement of the die onto the liquid solder for bonding onto the heated leadframe before the leadframe is cooled down again. This process is typically performed in a furnace in which the leadframes are indexed first to a solder dispensing module where solder is dispensed onto the prescribed pad of the leadframe, and from there to the bond position, where the furnace maintains the leadframe at a temperature above the melting temperature of the solder. This is followed by die attachment by a placement apparatus.

In the prior art methods, the placement apparatus performs the movements necessary for die placement, by pressing the die against the leadframe for a certain amount of time. The pressing motion may be performed with or without concomitant x and/or y motion (“scrub”).

Depending on the solder dispensing method used and the material of the leadframe, the liquid solder will behave in one of the following ways, For rectangular predetermined liquid solder patterns, the solder will stay within the pattern if this was chosen large enough to keep the liquid solder within this margin during the die attach process, which places the die on top of this solder distribution with a certain impact. The size of the margin depends on the wetting angle, i.e. the materials involves, as well as on the total amount of solder used for the attachment process. Depending on the materials used, this need to keep the solder within the pattern (the so-called “bleed-out” control) is very critical, making a reliable bleed out control impossible. Therefore, the surrounding area on the leadframe is commonly reserved as a bleed out margin. The width of the bleed out margin is often relatively large, but with the reduction in component and die sizes, a wide margin becomes increasing unacceptable. There is therefore a need to reduce solder liquid bleed out during the placement and bonding process. A hypothetical “impact-free” die attach process is not possible, because the impact is necessary to destroy the oxide layer on top of the solder distribution, which otherwise would lead to one very large void in the center of the die attach layer, causing the device to fail.

### SUMMARY OF THE INVENTION

Accordingly, the present invention provides, in one aspect, an improved die placement and bonding apparatus for attachment of a die onto the prescribed surface of a leadframe. The key improvement is for bleed out control, which is facilitated by a frame (also referred to as bond frame) that is used to limit the bleed out area during the bonding process. The apparatus is adapted for use with a furnace for heating the leadframe to a temperature above the melting temperature of the solder, and a solder dispenser that dispenses solder onto the leadframe. The apparatus contains a bond frame provided with an alignment mechanism, and a die placement mechanism. The frame has a perimeter side wall with a base defining a predetermined area therein, with dimensions larger than the dimensions of the die. The side wall is used to provide a solder liquid tight seal when it is placed on a prescribed surface of the leadframe. The alignment mechanism is coupled to the frame and allows the frame to be properly aligned with the leadframe before it is lowered onto the prescribed surface. The die placement mechanism is used for delivering and placing the die onto the liquid solder on the leadframe within the side wall.

In the preferred embodiment, a centering unit is coupled to the frame and the alignment mechanism for proper alignment with the leadframe. The side wall of the frame extends from the underside of a opening in the centering unit such that the base can form a liquid solder tight seal on the prescribed surface of the leadframe when the centering unit is lowered into the furnace containing the leadframe. In the most preferred embodiment, the frame is spring-mounted onto the centering unit to allow self-alignment.

In another aspect, a method for bleed out control during the die attachment and bonding process is provided using the apparatus described above. The method involves dispensing solder onto the prescribed surface of the heated leadframe. The substrate is then transported to the bond position, where the frame is then lowered onto the prescribed surface with the liquid solder being enclosed within the perimeter side wall of the frame such that the side wall forms a solder liquid tight seal with the prescribed surface. This is followed by the placing the die within the enclosed area using a process with impact. The placing unit then releases the die and the solder partially flows back underneath the die to form the final die attach layer before the bond frame is lifted up without disturbing the liquid solder and the substrate is then transported to the next position, where cooling starts.

### BRIEF DESCRIPTION OF THE DRAWINGS

FIG. 1 is a schematic drawing showing a complete die attachment system according to one embodiment of the present invention.

FIGS. 2A to 2C are the top side and perspective views of a frame according to one embodiment of the present invention.

FIGS. 3A and 3B are an exploded view and assembled view respectively of a centering unit and frame with parts of the furnace and leadframe according to the preferred embodiment of the present invention.

FIG. 4A shows a frame according to another embodiment of the present invention.

FIG. 4B shows the interaction of the liquid solder with the die and leadframe with the base of yet another frame according to the present invention.

### DESCRIPTION OF THE INVENTION

The following detailed description describes the preferred embodiment for implementing the underlying principles of the present invention. One skilled in the art should understand, however, that the following description is meant to be illustrative of the present invention, and should not be construed as limiting the principles discussed herein. In the following discussion, and in the claims the terms “including”, “having” and “comprising” are used in an open-ended fashion, and thus should be interpreted to mean “including but not limited to . . . ”.

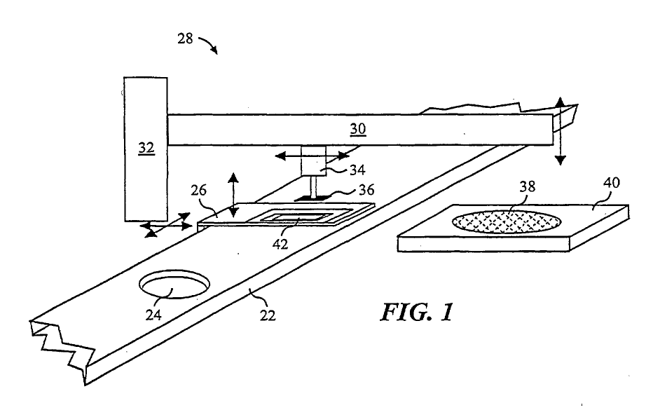

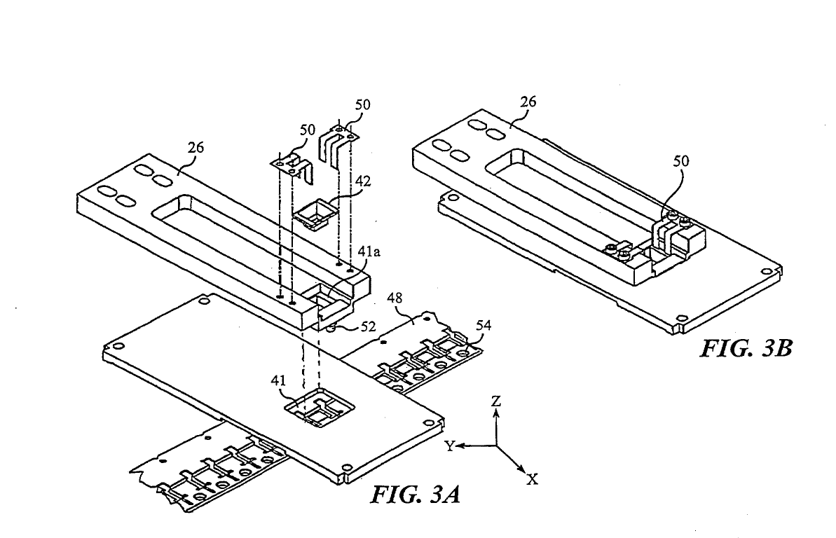

Referring first to FIG. 1, the frame for bleed-out control according to the present invention may be installed into a conventional die attachment system by simple modifications to the system to form an improved system. The improved system includes a furnace 22 with an indexer for heating the leadframe (not shown) to a temperature above the melting temperature of the solder, and for transferring it to various stations. At the dispensing position, an opening 24 is provided for access by the solder dispenser (not shown for ease of illustration) to dispense a solder dot or pattern onto the prescribed surface of each leadframe. Thereafter, the leadframe is transferred to the bonding position, in which a die placement and bonding apparatus is stationed. This apparatus includes a centering unit 26 and a die placement device 28. Die placement device 28 contains a bond arm 30 attached to a base 32. A bond head 34, including an alignment mechanism and a suction pick up mechanism, is coupled to the bond arm, for the transfer of a die 36 into the prescribed surface of the leadframe. The die may be an integrated circuit chip singulated from a semiconductor wafer 38 that is placed on a wafer table 40. Centering unit is positioned above an opening (not shown) in the furnace, and contains a window 41 (see FIG. 3A) through which the bond head 34, gains access into the furnace. A bond frame 42 is attached to the edge of the window and is described in detail below. An alignment mechanism (not shown) is coupled to the centering unit to align the bond frame to a predetermined position on the surface of the leadframe.

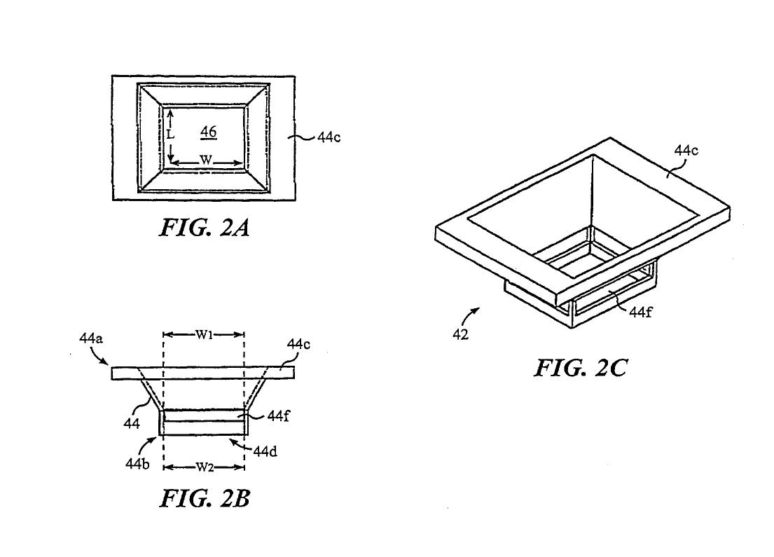

Referring now to FIGS. 2A-2C, the bond frame according to the preferred embodiment of the present invention contains a perimeter side wall 44 having a proximal end 44a and a distal end 44b. This proximal end 44a is formed into a rim 44c that facilitates interaction with the centering unit. The side wall 44 forms a perimeter for frame window 46. The distal end of the side wall ends with a base 44d having a straight edge that is capable of forming a solder liquid tight seal with the leadframe when properly aligned during operation. The base of the side wall also defines an enclosed and predetermined area having dimensions larger than the dimensions of the die. For example, the predetermined area of a square shape of 4×4 mm may be used for a 3×3 mm die. If the predetermined area is quadrilateral, the dimensions are defined with a length L and width W. The exact dimension and shape of the predetermined area depends on the user's needs, typically based on the maximum bleed out area that is tolerable, and may be readily adjusted by fabricating different bond frames. In the embodiment shown in FIGS. 2A-2C, a plurality of optional venting holes 44f are also provided at the proximal part of the side wall, while the distal end forms a uniform, straight edged wall that is used to retain liquid solder during the die placement process.

FIGS. 3A and 3B shows one example of how a bond frame is assembled onto a centering unit according to one embodiment of the present invention. In this embodiment, a pair of arcuate metallic strips 50 is. used as the resilient coupling mechanism to couple the bond frame onto the centering unit. The rim of the side wall engages flange 41a such that the rest of the side wall hangs over the edge of window 41 of the centering unit, with strips 50 limiting any upward movement of the bond frame. The alignment mechanism of the centering unit includes a centering pin 52 extending from the underside of the centering unit and in the vicinity of the window 41, and is adapted for mating with the centering holes 54 proximate the prescribed surfaces of the leadframe. A conventional x, y and z actuating mechanism is also provided for the alignment mechanism of the centering unit.

During operation, a leadframe 48 heated within the furnace is first transferred to the dispensing station (not shown) where a solder dot or pattern is placed on the prescribed surface of the leadframe. The leadframe is then transferred to the placement and bonding position, by indexing the prescribed leadframe surface directly below the window 41 of the centering unit and frame window 46 of the bond frame. The centering pin 52 and centering hole 54 act as an X/Y alignment mechanism, while the Z actuating mechanism of the centering unit lowers the centering unit and bond frame onto the prescribed surface of the leadframe. The bond head then places the die, which was picked from the wafer on the wafer table, onto the liquid solder dot on the prescribed surface of the leadframe enclosed by the perimeter side wall. The impact used for the die placement process may be predetermined according to the user's needs. The impact of the die on the liquid solder dot causes bleed out to occur, but is confined within the side walls of the frame. Once the die is placed onto the leadframe, the bond head releases the die and moves away. Upon release, part of the liquid solder margin seeps back under the die. The frame is then lifted. After the prescribed surface has been bonded, this position is sent for cooling. All movements are controlled by a machine controller and an alignment mechanism.

In the preferred embodiment, the bond frame is spring-mounted onto the centering unit, with metallic strips 50 acting as the spring. Such a spring-mounting mechanism allows for a small pivotal movement of the frame, such that a slight over-travel by the downward-moving centering unit will automatically ensure that every section of the base 44d is tightly aligned onto the prescribed surface. This eliminates the need for a pre-operation alignment step of the bond frame relative to the centering unit. Due to the self-alignment mechanism, the entire perimeter of the base automatically forms a liquid solder seal around the predetermined area of the leadframe and limits bleed out every time the die placement and attachment step is performed. The bond frame is designed and mounted in a way that the centering unit is able to center the substrate first before the bond frame settles onto the leadframe. This ensures that the substrate is always centered and that the base of the frame is always able to form a solder liquid tight border around the prescribed area, preventing bleed out of the solder material.

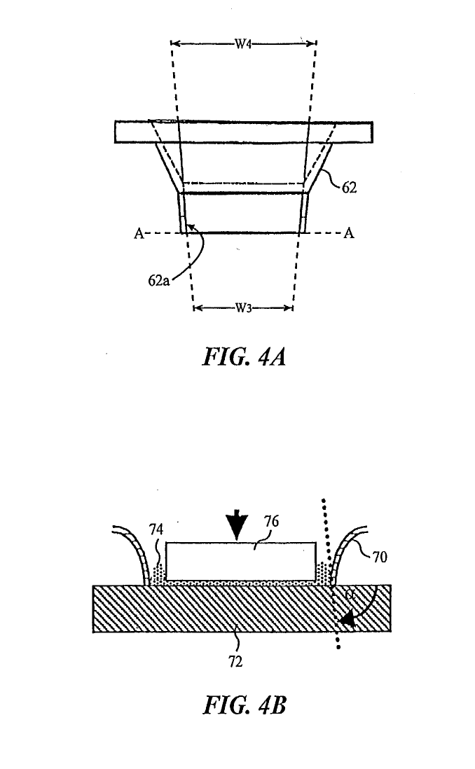

FIG. 4A shows another embodiment of a bond frame in which the side wall is inclined. For ease of explanation, the base of the side wall can be considered to define a plane with a cross section of the plane shown as line A-A. In this embodiment, the inner wall 62a of side wall at the distal end forms an angle of larger than 90 degrees with line A-A. i.e. width W3 is shorter than width W4.

FIG. 4B shows yet another embodiment of a bond frame in which the distal end 70 of the side wall is of a convex shape. FIG. 4B shows the distal end 70 being resiliently placed onto the prescribed surface of a leadframe, with the liquid solder material 74 being trapped within the predetermined area defined by the side wall even when a die 76 is pressed against the leadframe 72. The outwardly curved shape of the side wall enforces a larger wetting angle α, and minimizes any splashing of the liquid solder during the die placement process. This is particularly useful when a relatively large impact is used during die placement,

While the present invention has been described particularly with references to the aforementioned figures, it should be understood that the figures are for illustration only and should not be taken as limitation on the invention. In addition, it is clear that the method and apparatus of the present invention has utility in many applications where die attachment is required. It is contemplated that many changes and modifications may be made by one of ordinary skill in the art without departing from the spirit and the scope of the invention described. For example, the resilient coupling mechanism is described as a pair of metallic strips. It is clear that other mechanisms, such as coils springs can also be adapted for use.

The alignment mechanism described in the preferred embodiment is a centering unit with a centering pin and being controlled by an X,Y alignment mechanism. A Z-actuating mechanism is provided for the lowering movement. It is clear that other methods may also be used. For example, an optical system may be provided for vision alignment, with the X and Y movement performed by an alignment mechanism coupled to the furnace (e.g. an X,Y table), and the lowering mechanism controlling the Z-actuating mechanism coupled to the frame for the downward movement thereof.

1. A die placement and bonding apparatus for the attachment of a die to a leadframe, said apparatus adapted for introducing a die into a furnace, said furnace for heating a leadframe therein, said leadframe further having liquid solder provided on a prescribed surface thereon, said apparatus comprising:
a frame having a perimeter side wall with a base defining a predetermined area therein, said predetermined area having dimensions larger than the dimensions of said die, said side wall adapted to form a liquid solder tight seal when placed on said prescribed surface of said leadframe;
an alignment mechanism coupled to said frame for aligning said frame above the prescribed surface of a prescribed leadframe and lowering said frame thereon such that said liquid solder is confined within said predetermined area; and
a die placement mechanism for delivering and placing a die onto said liquid solder on said prescribed surface and within said predetermined area.

2. An apparatus according to claim 1 further comprising a centering unit having a centering element attached thereto and positioned thereunder for mating with a corresponding positioning element on said leadframe, said frame coupled to an opening in said centering unit.

3. An apparatus according to claim 2 wherein said alignment mechanism is coupled to said centering unit and controls the alignment of said centering element with said positioning element.

4. An apparatus according to claim 2 wherein said frame is coupled to said centering unit by a resilient coupling mechanism.

5. An apparatus according to claim 4 wherein said resilient coupling mechanism is a plurality of resilient metal strips.

6. An apparatus according to any one of the above claims wherein said perimeter side wall comprises at least one venting hole provided thereon to minimize gas turbulence created by the introduction of said frame into said furnace.

7. An apparatus according to claim 2 wherein said perimeter side wall comprises at least one venting hole provided thereon to minimize gas turbulence created by the introduction of said frame into said furnace; said perimeter side wall further comprises a distal end and a proximal end, said proximal end proximate said centering unit, said distal end adapted to direct contact with said leadframe during dispensing, with said venting hole provided adjacent said distal section of said perimeter side wall.

8. An apparatus according to claim 1 or 2 wherein said base of said perimeter side wall of said frame defines a planar surface, the interior surface of said side wall further forming a angle of more than 90 degrees with said planar surface.

9. An apparatus according to claim 8 wherein said perimeter side wall is further of a convex shape.

10. A method for attachment of a die onto a heated leadframe using liquid solder comprising:
providing a prescribed surface of a leadframe, said surface having liquid solder provided thereon;
lowering a frame onto said prescribed surface, said frame having a perimeter side wall defining a predetermined area therein, said predetermined area having dimensions larger than the dimensions of said die, said liquid solder enclosed within said side wall;
lowering and placing said die onto said prescribed surface within the perimeter of said side wall;
removing said frame from said prescribed surface; and
cooling said leadframe with said die placed thereon.

11. A method according to claim 10 wherein said die lowering and placing step is performed by a die placement mechanism and further comprises
retrieving a prescribed die;
lowering and pressing said die onto said leadframe at a predetermined impact;
releasing said die; and
moving said die placement mechanism away from said prescribed die.
